(19) United States
(12) Patent Application Publication
(10) Pub. No.: US 2025/0244656 A1
(43) Pub. Date: Jul. 31, 2025

(54) PROJECTION SCREEN AND MANUFACTURING METHOD THEREFOR, AND PROJECTION SYSTEM

(71) Applicant: HISENSE LASER DISPLAY CO., LTD., Shandong (CN)

(72) Inventors: Yoshihiro OSHIMA, Shandong (CN); Akira TASHIRO, Shandong (CN); Junichi OSAKO, Shandong (CN); Rui HOU, Shandong (CN)

(21) Appl. No.: 19/071,066

(22) Filed: Mar. 5, 2025

Related U.S. Application Data
(63) Continuation of application No. PCT/CN2023/122114, filed on Sep. 27, 2023.

(30) Foreign Application Priority Data
Dec. 29, 2022 (CN) 202211716324.6
Dec. 29, 2022 (CN) 202211716475.1
Feb. 10, 2023 (CN) 202310107687.8

(51) Int. Cl. G03B 21/60

(52) U.S. Cl. CPC G03B 21/60

(57) ABSTRACT

Disclosed are a projection screen, a manufacturing method therefor, and a projection system. The projection screen includes a diffusion layer, Fresnel structure layer with a plurality of Fresnel structures that are sequentially arranged, on a side of the diffusion layer, and a wavelength selection based reflection layer, covering at least part of a surface of the Fresnel structure of the Fresnel structure layer. A reflectivity for projection light emitted from a projection device by the wavelength selection based reflection layer is higher than a reflectivity for light of other wavelength bands by the wavelength selection based reflection layer. The projection light includes red laser light, green laser light, and blue laser light.

### CROSS REFERENCE TO RELATED APPLICATIONS

The application is a continuation application of International Application No. PCT/CN2023/122114, filed on Sep. 27, 2023, which claims priority to Chinese Patent Application No. 202211716475.1, filed with the China National Intellectual Property Administration on Dec. 29, 2022 and entitled “Projection Screen and Projection System”, Chinese Patent Application No. 202211716324.6, filed with the China National Intellectual Property Administration on Dec. 29, 2022 and entitled “Projection Screen and Projection System”, and Chinese Patent Application No. 202310107687.8, filed with the China National Intellectual Property Administration on Feb. 10, 2023 and entitled “Projection Screen and Manufacturing Method Therefor, and Projection System”, all of which are hereby incorporated by reference in their entireties.

### TECHNICAL FIELD

The application relates to the field of projection technology, in particular to a projection screen, a manufacturing method therefor and a projection system.

### BACKGROUND

With the popularization of laser display products, the market for laser televisions, which serve as large-screen alternatives to liquid crystal televisions (LCD TVs) and organic electroluminescent (EL) televisions, is rapidly expanding. Current front-projection systems typically work in conjunction with projection screens, where the projection device emits projection light that is incident on the projection screen. The light is then reflected by the projection screen into the viewer's eyes, allowing them to see the projected images.

White matte projection screens can uniformly reflect light from the light source and are relatively inexpensive. However, white matte projection screens are easily affected by external light when viewed in strong lighting conditions, making them unsuitable for watching movies or other content with frequent dark scenes. To address this issue, colored screens with the ability to absorb ambient light and reduce its brightness have been developed. However, such colored projection screens also absorb light emitted by the projection device, resulting in brightness loss for the projection light, thereby reducing image contrast.

### SUMMARY

The first aspect of the application provides a projection screen, including: a diffusion layer; a Fresnel structure layer located on a side of the diffusion layer, and one side of the Fresnel structure layer having a Fresnel structure; and a wavelength selection based reflection layer that covers at least part of a surface of the Fresnel structure of the Fresnel structure layer. The wavelength selection based reflection layer has a higher reflectivity for projection light emitted from the projection device compared to light in other wavelengths.

The second aspect of the application provides a method for manufacturing a projection screen, including:
a Fresnel structure manufacturing step, including: fabricating a Fresnel structure layer, where one side of the Fresnel structure layer has a plurality of Fresnel structures, and the Fresnel structures include interconnected inclined faces and connection faces;
a light-reflective layer manufacturing step, including: forming a discontinuous first film on the inclined faces of the Fresnel structures, and forming a continuous second film layer on the first film;
a surface functional layer manufacturing step, including: forming a surface functional layer on a side of the Fresnel structure layer that includes the light-reflective layer.

The third aspect of the application provides a projection system, which includes: a projection device for emitting projection light; and a projection screen on a light-emitting side of the projection device, where the projection screen is the projection screen described above. The projection device is an ultra-short-focus laser projection device, which includes: a three-color laser source for emitting three primary color lasers; a light modulator on a light-emitting side of the three-color laser source for modulating the lasers emitted by the light source; and a projection lens on a light-emitting side of the light modulator.

### BRIEF DESCRIPTION OF FIGURES

To more clearly describe the technical solutions of the embodiments of the application, a brief introduction to the drawings used in the embodiments is provided below. It should be noted that the drawings described below are merely some examples of the application. For those skilled in the art, other drawings can be obtained based on these drawings without requiring creative effort.

FIG. 1 shows a structural schematic diagram of a projection system provided in embodiments of the application.

FIG. 2 shows a first structural schematic diagram of a projection screen in related art.

FIG. 3 shows a second structural schematic diagram of a projection screen in related art.

FIG. 4 shows a first structural schematic diagram of a projection screen provided in embodiments of the application.

FIG. 5 shows a first structural schematic diagram of a wavelength selection based reflection layer provided in embodiments of the application.

FIG. 6 shows a second structural schematic diagram of a wavelength selection based reflection layer provided in embodiments of the application.

FIG. 7 shows a reflectivity curve of the wavelength selection based reflection layer for light in different wavelength bands provided in embodiments of the application.

FIG. 8 shows a distribution curve of ambient light intensity provided in embodiments of the application.

FIG. 9 shows a reflectivity curve of ambient light incident on the wavelength selection based reflection layer provided in embodiments of the application.

FIG. 10 shows a curve illustrating a relationship between the thickness of the translucent layer and the attenuation rate of ambient light intensity provided in embodiments of the application.

FIG. 11 shows a first curve illustrating a relationship between wavelength and reflectivity provided in embodiments of the application.

FIG. 12 shows a second curve illustrating a relationship between wavelength and reflectivity provided in embodiments of the application.

FIG. 13 shows a third curve illustrating a relationship between wavelength and reflectivity provided in embodiments of the application.

FIG. 14 shows a fourth curve illustrating a relationship between wavelength and reflectivity provided in embodiments of the application.

FIG. 15 shows a fifth curve illustrating a relationship between wavelength and reflectivity provided in embodiments of the application.

FIG. 16 shows a sixth curve illustrating a relationship between wavelength and reflectivity provided in embodiments of the application.

FIG. 17 shows a second structural schematic diagram of a projection screen provided in embodiments of the application.

FIG. 18 shows a comparison chart of reflectivity curves for light at different incident angles provided in embodiments of the application.

FIG. 19 shows a third structural schematic diagram of a projection screen provided in embodiments of the application.

FIG. 20 shows a reflectivity curve of the wavelength selection based reflection layer for light incident at an angle of 65° provided in embodiments of the application.

FIG. 21 shows a reflectivity curve of the wavelength selection based reflection layer for light incident at an angle of 10° provided in embodiments of the application.

FIG. 22 shows a reflectivity curve after two reflections by the wavelength selection layer provided in embodiments of the application.

FIG. 23 shows a relative intensity curve of ambient light incident on the projection screen provided in embodiments of the application.

FIG. 24 shows a relative intensity curve of ambient light after reflection by the projection screen provided in embodiments of the application.

FIG. 25 shows a fourth structural schematic diagram of a projection screen provided in embodiments of the application.

FIG. 26 shows a fifth structural schematic diagram of a projection screen provided in embodiments of the application.

FIG. 27 shows a sixth structural schematic diagram of a projection screen provided in embodiments of the application.

FIG. 28 shows a seventh structural schematic diagram of a projection screen provided in embodiments of the application.

FIG. 29 shows an eighth structural schematic diagram of a projection screen provided in embodiments of the application.

FIG. 30 shows a ninth structural schematic diagram of a projection screen provided in embodiments of the application.

FIG. 31 shows a tenth structural schematic diagram of a projection screen provided in embodiments of the application.

FIG. 32 shows a third structural schematic diagram of a projection screen in related art.

FIG. 33 shows a fourth structural schematic diagram of a projection screen in related art.

FIG. 34 shows a flowchart of a method for manufacturing a projection screen provided in embodiments of the application.

FIG. 35 shows a first schematic diagram of a process for manufacturing the Fresnel structure layer provided in embodiments of the application.

FIG. 36 shows a second schematic diagram of a process for manufacturing the Fresnel structure layer provided in embodiments of the application.

FIG. 37 shows a coating thickness curve in related art.

FIG. 38 shows a coating thickness curve provided in embodiments of the application.

FIG. 39 shows a first schematic diagram of the structure of the reflection layer during the coating process provided in embodiments of the application.

FIG. 40 shows a second schematic diagram of the structure of the reflection layer during the coating process provided in embodiments of the application.

FIG. 41 shows a third schematic diagram of the structure of the reflection layer during the coating process provided in embodiments of the application.

FIG. 42 shows a fourth schematic diagram of the structure of the reflection layer during the coating process provided in embodiments of the application.

FIG. 43 shows an eleventh structural schematic diagram of a projection screen provided in embodiments of the application.

FIG. 44 shows a twelfth structural schematic diagram of a projection screen provided in embodiments of the application.

FIG. 45 shows a structural schematic diagram of a projection device provided in embodiments of the application.

Where:

1—projection screen; 2—projection device; 10—surface layer; 11—diffusion layer; 11′—surface functional layer; 111—second substrate; 112—diffusion material; 12—Fresnel structure layer; 121—Fresnel structure; x1—inclined face; x2—connection face; 122—third substrate; 13—reflective material layer; 13′—light-reflective layer; 14—binding layer; F—wavelength selection based reflection layer; 131—translucent layer; 132—reflection layer; 133—light-transmissive medium layer; 134—first substrate; 21—light source; 22—illumination path; 23—light modulator; 24—projection lens; s1—first film; s2—second film; f′—UV (ultraviolet) curable resin; M—mold; C—ambient light; L—projection light.

### DETAILED DESCRIPTION

To make the objectives, features, and advantages of the application clearer, the following will provide further explanation in conjunction with the accompanying figures and embodiments. It should be noted that the example embodiments can be implemented in various forms and should not be limited to the embodiments described herein. Instead, these embodiments are provided to make the application more comprehensive and complete and to fully convey the concept of the example embodiments to those skilled in the field. In the figures, identical reference numerals denote the same or similar structures, and repetitive descriptions are thus omitted. Positional and directional terms described in the application are explained with reference to the figures but can be adjusted as needed, and any adjustments remain within the scope of the application. The accompanying figures are for illustrating relative positional relationships and do not represent actual proportions.

With the popularization of laser display products, the market for laser televisions, as an alternative to liquid crystal televisions and organic EL televisions, has rapidly expanded. To achieve better brightness and display effects, projection devices are generally used in conjunction with projection screens.

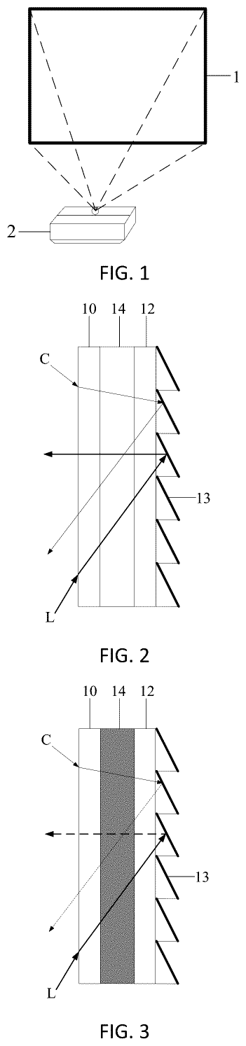

FIG. 1 shows a structural diagram of a projection system provided in embodiments of the application.

As shown in FIG. 1, the projection system includes: a projection device 2 and a projection screen 1.

The projection screen 1 is located on a light-emitting side of the projection device 2, with the viewer facing the projection screen 1. The projection device 2 emits projection light, which incidents on the projection screen 1 and is reflected toward the viewer, enabling the viewer to see the projected image.

Ultra-short-focus projection devices, with features of short projection distances and large projection images, are particularly suitable for home applications. The projection system provided in embodiments can use an ultra-short-focus projection device.

Currently, front-projection systems use projection screens with Fresnel structures. Fresnel structures have specific tilt angles, allowing projection light emitted by the projection device to be reflected toward the viewer after striking the reflective material on the Fresnel structure, enabling more projection light to enter the viewer's eyes.

FIG. 2 illustrates a first structural diagram of a projection screen in related art.

As shown in FIG. 2, the projection screen includes: a surface layer 10, a Fresnel structure layer 12, and a binding layer 14. The surface layer 10 and the Fresnel structure layer 12 are adhered together via the binding layer 14. The side of the Fresnel structure layer 12 facing away from the surface layer 10, i.e., the side away from the viewer, contains the Fresnel structure. A reflective material layer 13 is formed on the surface of the Fresnel structure. The reflective material layer 13 is typically made of reflective metals such as aluminum, applied to the surface of the Fresnel structure. As a result, light striking the reflective material layer 13 on the surface of the Fresnel structure is reflected.

As shown in FIG. 2, projection light L emitted by the projection device enters the projection screen from the surface layer 10, and upon reaching the Fresnel structure, it is reflected by the reflective material layer 13 on the Fresnel structure, directing the light toward the viewer.

Meanwhile, ambient light C entering the projection screen from the surface layer 10 also strikes the reflective material layer 13 on the Fresnel structure. Some of this ambient light is reflected by the reflective material layer 13 and exits the projection screen. This reflected ambient light can enter the viewer's eyes, reducing the contrast of the projected image.

To address this issue, films of the projection screen are often colored so that the colored film layers can absorb incident ambient light, reducing ambient light reflection.

FIG. 3 shows a second structural diagram of a projection screen in related art.

As shown in FIG. 3, the binding layer 14 can be colored by mixing dye, carbon black, or other light-absorbing substances into the material of the binding layer 14. This allows the binding layer 14 to absorb ambient light upon entry. However, since the colored film layers in the projection screen absorb light across all wavelengths, projection light L striking the colored film layer (e.g., the binding layer 14) experiences reduced efficiency after passing through it, failing to improve contrast effectively.

In view of this, the application provides a projection screen capable of selectively reflecting projection light of the wavelength band emitted by the projection device while significantly reducing the reflectivity of light of other wavelength bands, thereby greatly enhancing the contrast of the projected image.

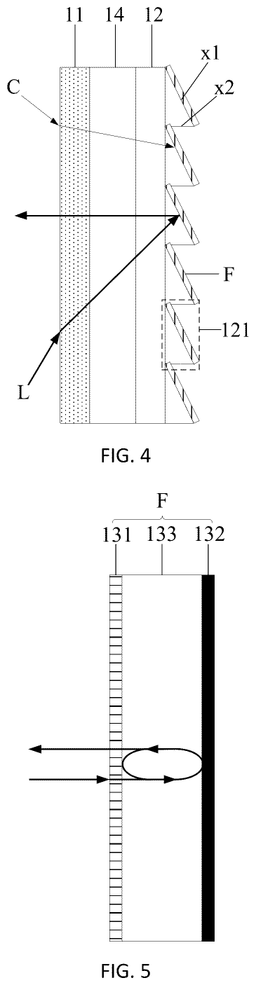

FIG. 4 illustrates a third structural diagram of a projection screen provided in embodiments of the application.

As shown in FIG. 4, the projection screen includes: a diffusion layer 11, a Fresnel structure layer 12, and a wavelength selection based reflection layer F.

The diffusion layer 11 is the outermost film layer of the projection screen and is positioned closest to the viewer. The diffusion layer 11 has a light-diffusing function. The projection system provided in embodiments of the application can utilize a laser source. Lasers have high collimation, meaning projection light has a small divergence angle. The light reflected by the projection screen also maintains high collimation, resulting in a narrow viewing angle. By incorporating the diffusion layer 11, the light passing the diffusion layer has various exit angles, allowing the light exiting the screen to have a certain divergence angle, increasing the viewing angle for the audience. Additionally, the diffusion layer 11 helps eliminate laser speckles, optimizing the projected image.

The Fresnel structure layer 12 is located on a side of the diffusion layer, specifically on the side of the diffusion layer 11 facing away from the viewer. On one surface of the Fresnel structure layer 12, a plurality of Fresnel structures 121 are arranged according to a set pattern. Depending on the application occasions and production techniques, the Fresnel structures 121 may form concentrically circular patterns, horizontally extending linear patterns, or periodic checkerboard patterns, among others. These configurations are not limited in the application.

As shown in FIG. 4, each Fresnel structure 121 includes an inclined face x1 and a connection face x2, which are interconnected. The inclined face x1 is tilted relative to a plane of the diffusion layer 11. The tilt angle of the inclined face x1 is determined based on the incident and reflection angles of the projection light. The tilt angle of the inclined face x1 ensures that projection light emitted by the projection device is reflected toward the viewer when it strikes the reflective structure on the inclined face x1. When the viewer is positioned directly in front of the projection screen, the inclined faces x1 of the Fresnel structures 121 reflect the projection light directly forward. The connection face x2, which connects the inclined faces x1, does not contribute to reflecting the projection light.

The wavelength selection based reflection layer F covers at least part of the surface of the Fresnel structure 121 in the Fresnel structure layer 12, and is used for selectively reflecting incident light. In embodiments of the application, the wavelength selection based reflection layer F has a higher reflectivity for projection light than for light in other wavelength bands. By replacing the reflective material layer on the surface of the Fresnel structure 121 with the wavelength selection based reflection layer F, the wavelength selection based reflection layer F can selectively reflect the projection light emitted by the projection device, while significantly reducing the reflectivity for light in other wavelength bands. This enables a black appearance when the projection device is off and a bright display when the projection device is on, which significantly improves the contrast of the projection image.

As shown in FIG. 4, the projection light L emitted by the projection device enters the projection screen from the side with the diffusion layer 11. Upon reaching the Fresnel structure 121, it is reflected by the wavelength selection based reflection layer F on the surface of the Fresnel structure, directing the light toward the viewer.

Meanwhile, ambient light C enters the projection screen from the side with the diffusion layer 11. When the ambient light C strikes the wavelength selection based reflection layer F on the surface of the Fresnel structure 121, the wavelength selection based reflection layer F reflects only the projection light, while the reflectivity for light in other wavelength bands is lower. This reduces the reflection of ambient light, thereby improving the contrast of the projection light.

Specifically, the wavelength selection based reflection layer F is based on the principle of a resonant cavity to select the light of the wavelength emitted toward the viewer. The light of other wavelengths is confined within the resonant cavity and cannot exit, achieving the effect of selectively reflecting the projection light.

FIG. 5 illustrates a structural diagram of the wavelength selection based reflection layer provided in embodiments of the application.

As shown in FIG. 5, the wavelength selection based reflection layer F includes at least: a translucent layer 131, a reflection layer 132, and a light-transmissive medium layer 133. The translucent layer 131 is located on a side closest to the diffusion layer 11 and is the layer in the wavelength selection based reflection layer F nearest to the viewer. The reflection layer 132 is positioned on a side of the translucent layer 131 facing away from the diffusion layer 11 and is the layer in the wavelength selection based reflection layer F farthest from the viewer. The translucent layer 131 and the reflection layer 132 are spaced apart by a certain distance. The light-transmissive medium layer 133 is located between the translucent layer 131 and the reflection layer 132, forming a resonant cavity structure composed of the translucent layer 131, the reflection layer 132, and the light-transmissive medium layer 133.

The translucent layer 131 has both transmissive and reflective properties, allowing the projection light to enter the wavelength selection based reflection layer F when incident on the projection screen. After oscillating and amplifying within the resonant cavity, the projection light can also exit from the side of the translucent layer 131. The translucent layer 131 can be made from a laminated structure of metals such as Al, Nb, Ag, and Ti, which is not limited here. The translucent layer 131 can be manufactured by methods such as sputtering or evaporation, which is not limited.

It should be noted that the translucent layer 131 has transmissive and reflective properties, but this does not limit its transmissivity and reflectivity to be exactly 50% respectively. The intention is to indicate that this layer can partially transmit and partially reflect light. In specific implementations, it is typically configured to transmit most or a large proportion of the light and reflect a small proportion of the light.

The reflection layer 132 serves to reflect light and is located on a side farthest from the viewer. It does not need to transmit light, so materials that have reflective properties but are not light-transmissive can be used. The reflection layer 132 can be made from materials such as aluminum, aluminum alloys, silver, or silver alloys, with a thickness greater than that of the translucent layer 131. For example, the reflection layer 132 can be made from laminated structures of Al, AlSi (aluminum alloy), or Ag, AgPaCu (silver alloy), which is not limited. The reflection layer 132 can be manufactured by methods such as sputtering or evaporation, but this is also not limited.

The thickness of the light-transmissive medium layer 133 determines the cavity length of the resonant cavity. Therefore, the product of the refractive index and the thickness of the light-transmissive medium layer 133 determines the wavelength of the light emitted toward the viewer from the resonant cavity and the wavelength that is extinguished within the resonant cavity. When designing the resonant cavity, dielectric materials must be selected such that the product of the refractive index and the thickness satisfies the resonance conditions for the projection light emitted by the projection device. The light-transmissive medium layer 133 can be made from materials such as metal oxides, nitrides, or transparent resins. For example, the light-transmissive medium layer 133 can be made from metal oxides or nitrides such as TiO₂, Nb₂O₅, ZrO₂, Al₂O₃, ZnO₂, SiO₂, and fabricated by using methods such as reactive sputtering, electron beam (EB) evaporation, chemical vapor deposition (CVD); or can be a laminated structure made of one or more of transparent resins like PMMA, PC, or PS, and fabricated by using wet processing techniques such as gravure printing or coating, which is not limited.

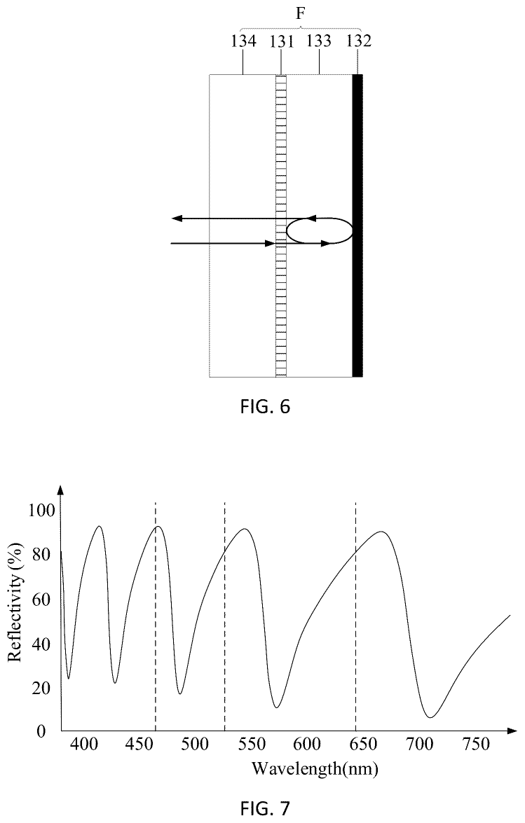

FIG. 6 illustrates a second structural diagram of the wavelength selection based reflection layer provided in embodiments of the application.

In some embodiments, as shown in FIG. 6, the wavelength selection based reflection layer F may also include a first substrate 134, which is located on a side of the translucent layer 131 facing away from the light-transmissive medium layer 133. The first substrate serves as the substrate for the resonant cavity, providing structural support. In specific implementations, the first substrate 134 can be made from materials such as polyethylene terephthalate (PET), which is not limited.

The following provides a detailed explanation of the resonant principle of the wavelength selection based reflection layer.

If the reflectivity of the translucent layer 131 is rH, its transmissivity is tH; the reflectivity of the reflection layer 132 is rM; the electric field intensity of the incident light entering the wavelength selection based reflection layer is Ei, and the electric field intensity of the reflected light is Er, then the relationship is given by:

$$Er = Ei ( - rH ) + {E}_{i} {t}_{H}^{2} {r}_{M} {e}^{- i ϕ} + {E}_{i} {t}_{H}^{2} {r}_{M}^{2} {r}_{H} {e}^{- 2 i ϕ} = Ei ( - rH ) + {E}_{i} {t}_{H}^{2} {r}_{M} {e}^{- i ϕ} {\sum }_{n = 0}^{∞} ( {r}_{H} {r}_{M} {e}^{- i ϕ} ) n = Ei ( - rH + \frac{{t}_{H}^{2} {r}_{M} {e}^{- i ϕ}}{1 - {r}_{H} {r}_{M} {e}^{- i ϕ}} ) .$$

The phase when the resonance becomes maximum is: Ø=21m; m is a natural number.

For the relationship using the cavity length of the resonant cavity, then: 2 nL=mλ; m is a natural number.

Here, n represents the refractive index of the light-transmissive medium layer, and L represents the thickness of the light-transmissive medium layer, which is the cavity length of the resonant cavity.

From the above relationship, it can be seen that selecting a dielectric material with an appropriate refractive index as the light-transmissive medium layer and setting the layer to an appropriate thickness can enhance the reflection of projection light by the resonant cavity.

In the embodiment, the projection light source can utilize a three-color laser source device that emits red laser light, green laser light, and blue laser light. By adjusting the refractive index and thickness of the light-transmissive medium layer, the resonant cavity can simultaneously enhance the reflection of red laser light, green laser light, and blue laser light while attenuating the reflection of light in other wavelength bands, thereby improving the contrast of the projection light.

FIG. 7 illustrates the reflectivity curve of the wavelength selection based reflection layer for light in different wavelength bands. The dashed lines indicate the central wavelengths of red laser light, green laser light, and blue laser light. As shown in FIG. 7, the wavelength selection based reflection layer exhibits high reflectance at the wavelengths of red laser light, green laser light, and blue laser light emitted by the projection device, while the reflectance for other wavelength bands is significantly reduced. This is beneficial for improving the contrast of projection light.

In practical implementation, due to differences in the projection light sources used, the wavelength bands of the lasers emitted by the laser devices may vary, and each laser usually has a central wavelength with higher emitted energy. Even when different lasers emit lasers of the same color, their central wavelengths may differ slightly. For example, the central wavelength of red laser light can be 635 nm, 650 nm, or 643 nm, with manufacturing tolerances causing fluctuations of +8 nm. The central wavelength of green laser light can be 520 nm, 525 nm, or 532 nm, with fluctuations of +8 nm. Blue laser light can have central wavelengths of 445 nm or 465 nm, with fluctuations of +8 nm.

When designing the wavelength selection based reflection layer, the refractive index and thickness of the light-transmissive medium layer should be determined based on the central wavelength of the light to be reflected. Additionally, in ultra-short-focus projection devices, there is projection light that is incident on the projection screen at large angles due to the small distance between the device and the screen. Large-angle incidence on the wavelength selection based reflection layer can shift the reflected wavelength range. Thus, theoretically, the narrower the wavelength range reflected by the layer, the better. Considering compatibility with projection light sources, the embodiment allows a fluctuation range of +5 nm to +20 nm for the central wavelengths of light reflected by the wavelength selection based reflection layer. The central wavelengths of the selected light can include 635 nm, 650 nm, or 643 nm for red light; 520 nm, 525 nm, or 532 nm for green light; and 445 nm or 465 nm for blue light, without limitation.

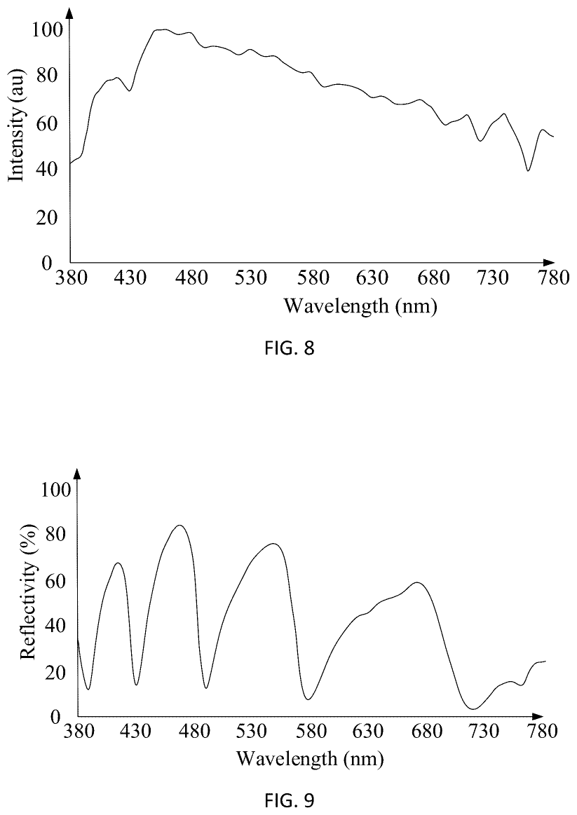

FIG. 8 shows the intensity distribution curve of ambient light, and FIG. 9 illustrates the reflectivity curve of ambient light incident on the wavelength selection based reflection layer. In FIG. 8, the intensity distribution curve of ambient light depicts the spectral distribution of the CIE standard light source D65, which corresponds to average midday light in Europe/Northern Europe and is known as the daylight light source. This embodiment uses the D65 light source as a standard for calculations.

By comparing FIGS. 8 and 9, it can be seen that the intensity of ambient light decreases by approximately 45% after passing through the wavelength selection based reflection layer. As can be seen from FIG. 7, it is evident that the attenuation caused by the wavelength selection based reflection layer for three-color lasers is approximately 20%. Therefore, based on the attenuation rates of projection light and ambient light, the intensity of projection light is approximately (100−20)/(100−45)≈1.45 times that of ambient light, thus enhancing the contrast of the projection light.

Based on the above relationship of electric field intensity, the power Pt of the reflected light reflected by the wavelength selection based reflection layer is given by:

$${P}_{t} = {\vert {E}_{r} \vert}^{2} = \frac{{[ ( {t}_{H}^{2} + {r}_{H}^{2} ) {r}_{M} - rH ]}^{2} + 4 {rHr}_{M} ( {t}_{H}^{2} + {r}_{H}^{2} ) {sin}^{2} ( ϕ / 2 )}{{( 1 - rHrM )}^{2} + 4 {rHr}_{M} {sin}^{2} ( ϕ / 2 )} {\vert {E}_{i} \vert}^{2} .$$

The power of the reflected light is maximized when the sine term is 1 and minimized when it is 0. To enhance the contrast of projection light, the reflection and transmission rates of the translucent layer should be set to minimize the non-sine terms.

Based on simulation tests, for a projection device emitting red laser light with a central wavelength of 643 nm, green laser light with a central wavelength of 525 nm, and blue laser light with a central wavelength of 425 nm, the optimal parameters are as follows: the thickness of the translucent layer 131 is within the range of 2-20 nm, the thickness of the reflection layer 132 is less than 100 nm, and the product of the thickness and refractive index of the light-transmissive medium layer 133 is within the range of 1200-1400 nm. When the reflection layer 132 uses metal materials, it must have sufficient thickness to ensure high reflectance. As such, the thickness of the reflection layer 132 should be greater than50 nm.

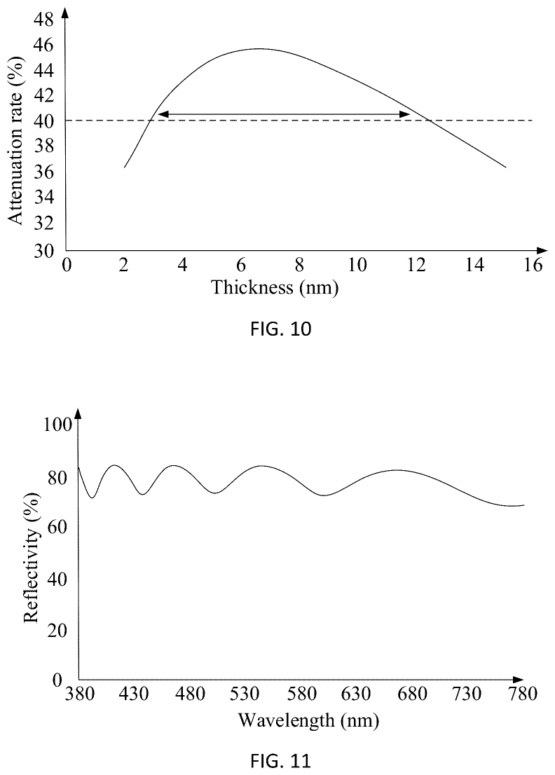

FIG. 10 shows the relationship between the thickness of the translucent layer and the attenuation rate of ambient light intensity. For the calculation of ambient light attenuation rate, the D65 light source spectrum is used as a representative. Based on this invention, increasing the attenuation rate of ambient light improves contrast.

As shown in FIG. 10, when the translucent layer 131 uses aluminum (Al), the reflection layer 132 uses Al, the light-transmissive medium layer 133 uses Nb₂O₅, and the first substrate is PET, the attenuation rate exceeds 40% for a translucent layer thickness of approximately 3-12 nm. The maximum attenuation rate occurs near a thickness of 7 nm. Therefore, when using this structure, the thickness of the translucent layer 131 can be set between 3-12 nm, preferably around 7 nm.

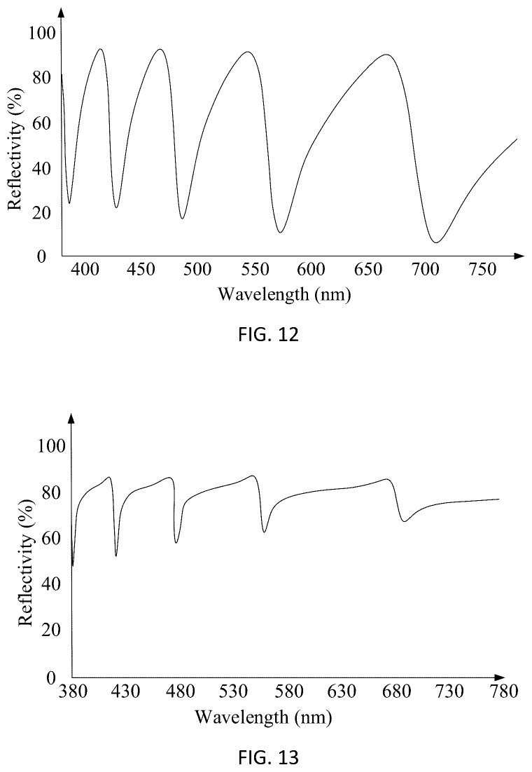

FIG. 11 shows a first curve illustrating a relationship between wavelength and reflectivity provided in embodiments of the application, FIG. 12 shows a second curve illustrating a relationship between wavelength and reflectivity provided in embodiments of the application, and FIG. 13 shows a third curve illustrating a relationship between wavelength and reflectivity provided in embodiments of the application. In these figures, simulations are conducted assuming that the translucent layer 131 uses Al, the reflection layer 132 uses Al, the light-transmissive medium layer 133 uses Nb₂O₅, and the first substrate 134 uses PET. With a fixed reflection layer thickness of 200 nm and a light-transmissive medium layer thickness of 609 nm: FIG. 11 shows the wavelength-reflectivity relationship when the thickness of the translucent layer 131 is 0, FIG. 12 shows the wavelength-reflectivity relationship when the thickness of the translucent layer 131 is 7 nm, and FIG. 13 shows the wavelength-reflectivity relationship when the thickness of the translucent layer 131 is 30 nm.

In FIG. 11, when the translucent layer uses Al and its thickness is 0, the reflectance is determined solely by the refractive index difference between the light-transmissive medium layer 133 and the first substrate 134, resulting in reduced wavelength selectivity.

In FIGS. 12 and 13, as the thickness of the translucent layer 131 increases, the transmission component to the resonant cavity decreases, and the reflection component by the translucent layer becomes dominant. Maximum wavelength selectivity is achieved when the thickness of the translucent layer 131 is 7 nm.

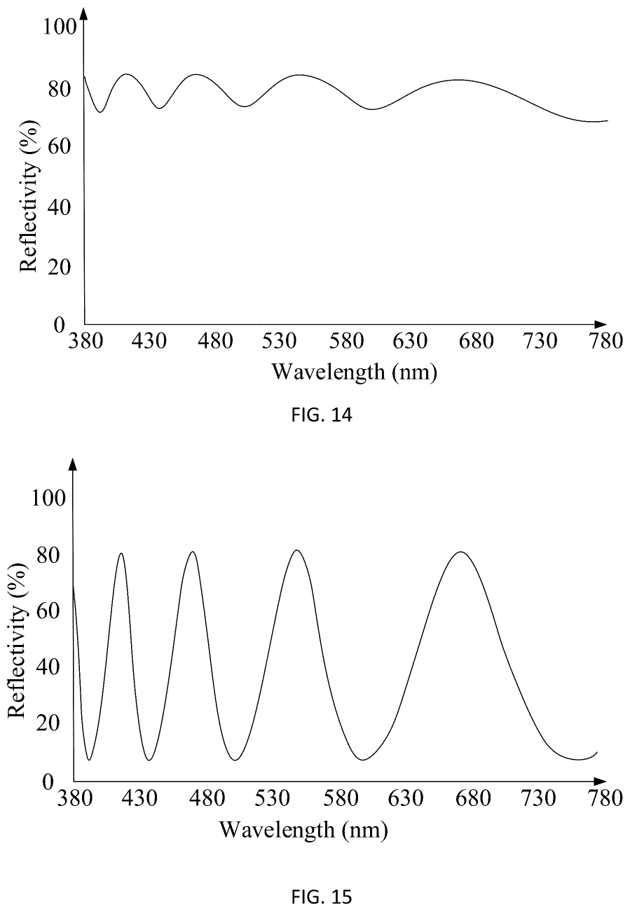

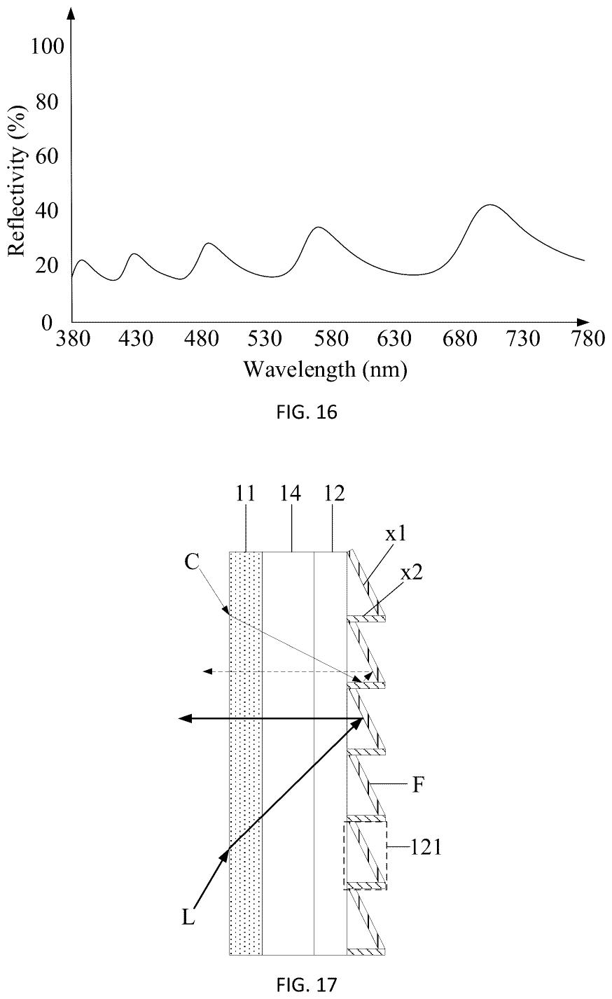

FIG. 14 shows a fourth curve illustrating a relationship between wavelength and reflectivity provided in embodiments of the application, FIG. 15 shows a fifth curve illustrating a relationship between wavelength and reflectivity provided in embodiments of the application, and FIG. 16 shows a sixth curve illustrating a relationship between wavelength and reflectivity provided in embodiments of the application. In FIGS. 14-16, simulations are conducted assuming that the translucent layer 131 uses niobium (Nb), the reflection layer 132 uses Al, the light-transmissive medium layer 133 uses Nb₂O₅, and the first substrate 134 uses PET. With a fixed reflection layer thickness of 200 nm and a light-transmissive medium layer thickness of 609 nm: FIG. 14 shows the wavelength-reflectivity relationship when the translucent layer 131 has a thickness of 0, FIG. 15 shows the wavelength-reflectivity relationship when the translucent layer 131 has a thickness of 15 nm, and FIG. 16 shows the wavelength-reflectivity relationship when the translucent layer 131 has a thickness of 70 nm.

In FIG. 14, when the translucent layer uses Nb and has a thickness of 0, the reflectance is determined solely by the refractive index difference between the light-transmissive medium layer 133 and the first substrate 134, resulting in reduced wavelength selectivity.

In FIGS. 15 and 16, as the thickness of the translucent layer 131 increases, the transmission component to the resonant cavity decreases. Unlike the case with Al, for Nb, the reflection component on the surface of Nb, which inherently has low reflectance, becomes dominant. Maximum wavelength selectivity is achieved at a thickness of approximately 15 nm.

From the above analysis, it is evident that the thickness of the translucent layer 131 significantly affects wavelength selectivity. In practical implementation, the thickness of the translucent layer 131 should be adjusted based on the specific structure, materials, and thickness of each layer in the wavelength selection based reflection layer F to maximize wavelength selectivity.

In some embodiments, as shown in FIG. 4, the wavelength selection based reflection layer F can cover the inclined face x1 of the Fresnel structure 121. Since the inclined angle of the inclined face x1 in the Fresnel structure is designed based on the incidence angle of the projection light, and the connection face x2 serves to connect the inclined face x1 rather than directly receiving and reflecting projection light, the wavelength selection based reflection layer F can be applied exclusively to the inclined face x1. This configuration allows the wavelength selection based reflection layer F on the inclined face x1 of the Fresnel structure 121 to reflect incident projection light, while projection light or ambient incident on the connection face x2 is directly transmitted without reflection to avoid interference on the projection light, as the connection face lacks the wavelength selection based reflection layer F.

FIG. 17 illustrates a second schematic structural diagram of the projection screen provided by embodiments of the disclosure.

In some embodiments, as shown in FIG. 17, the wavelength selection based reflection layer F can cover both the inclined face x1 and the connection face x2 of the Fresnel structure 121. Research and testing reveal that the wavelength selectively reflected by the wavelength selection based reflection layer F varies depending on the incidence angle.

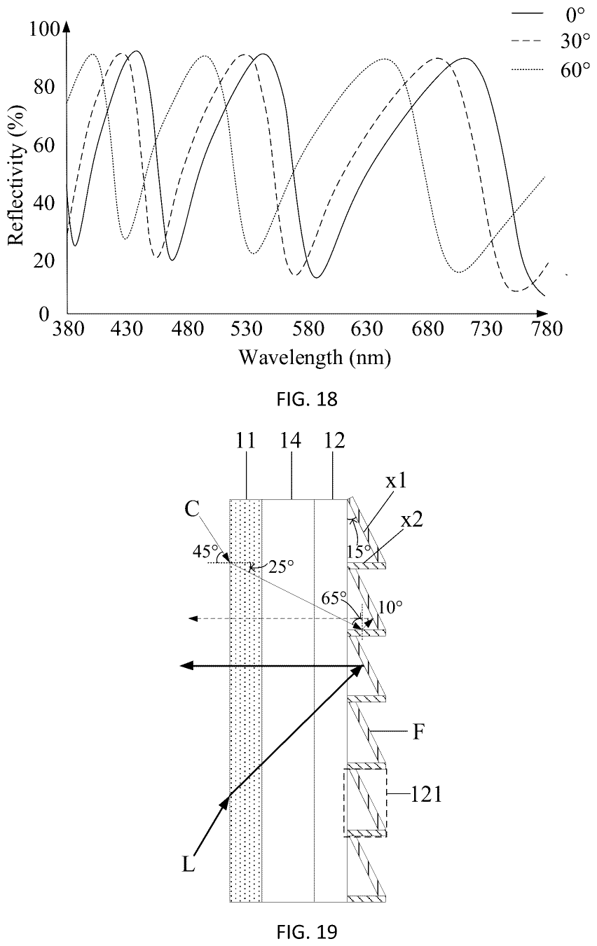

FIG. 18 shows a comparison of reflectivity curves for light at different incidence angles, at 0°, 30°, and 60° respectively, onto the wavelength selection based reflection layer.

As can be seen in FIG. 18, as the incidence angle changes (increases), the wavelength of light selectively reflected by the wavelength selection based reflection layer shifts toward the shorter wavelength range. Since the Fresnel structure in the projection screen is designed for the projection light's incidence angle, while ambient light comes from various directions, ambient light undergoes diffusion in the diffusion layer 11 before reaching the wavelength selection based reflection layer F at diverse incidence angles. This light often reflects multiple times on the surface of the wavelength selection based reflection layer, with changes in the incidence angle during the process. Due to the wavelength selection based reflection layer's dependence on the incidence angle, ambient light undergoes attenuation across the entire visible spectrum after multiple reflections, significantly enhancing the proportion of projection light energy in the reflected light and improving contrast.

FIG. 19 illustrates a third schematic structural diagram of the projection screen provided by embodiments of the application.

Taking the projection screen structure in FIG. 19 as an example, the inclined face x1 of the Fresnel structure 121 has a tilt angle of 15°, and the connection face x2 is perpendicular to the plane of the projection screen. Ambient light C with an incidence angle of 45° enters the diffusion layer 11, refracts at an angle of 25°, and subsequently reaches the wavelength selection based reflection layer F at an incidence angle of 65°. The ambient light first hits the wavelength selection based reflection layer on the connection face x2, is reflected by the wavelength selection based reflection layer on the connection face x2, and then reaches the wavelength selection based reflection layer on the inclined face x1. In other words, the ambient light undergoes two reflections in the wavelength selection based reflection layer, with incidence angles of 65° and 10°, respectively.

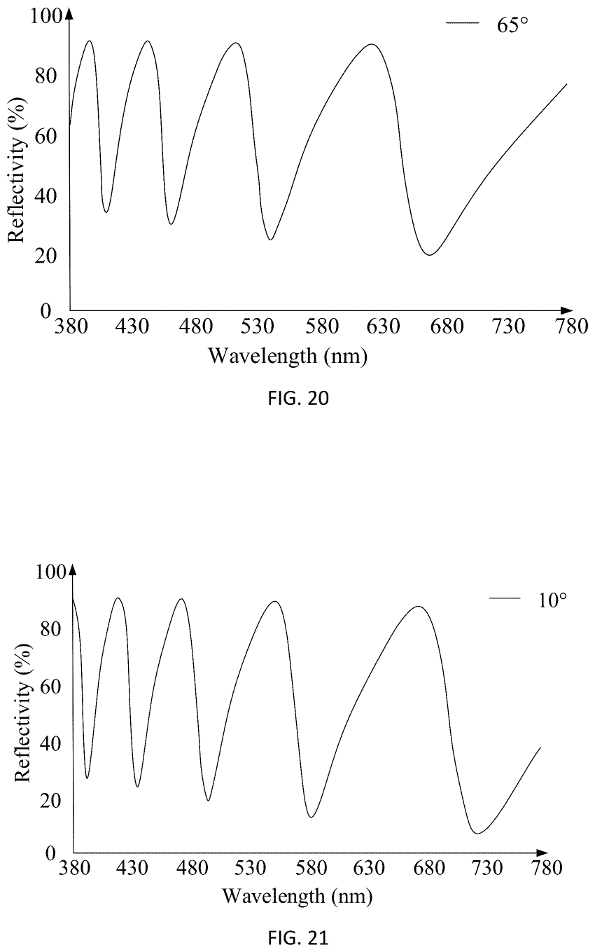

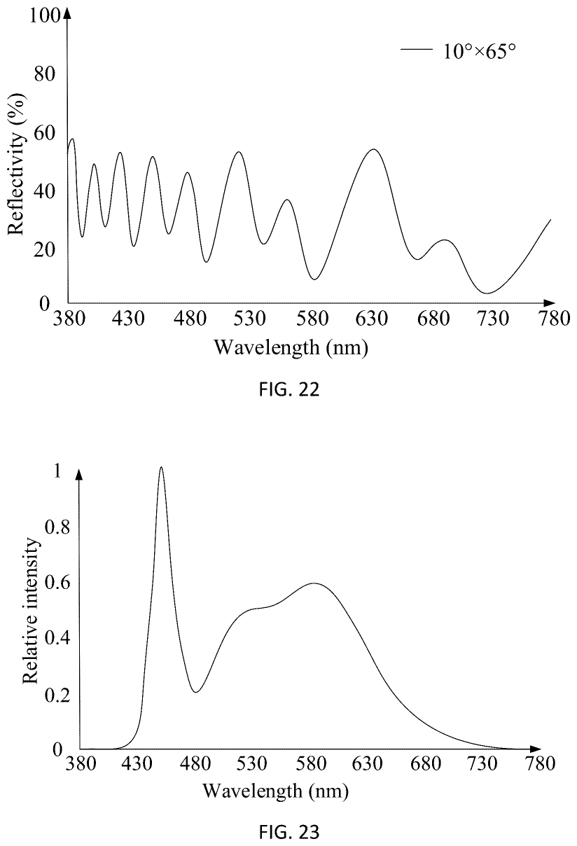

FIG. 20 shows the reflection curve of the wavelength selection based reflection layer for light with an incidence angle of 65°, and FIG. 21 shows the reflection curve of the wavelength selection based reflection layer for light with an incidence angle of 10°, respectively. FIG. 22 shows the reflection curve after two reflections in the wavelength selection layer.

As seen in FIGS. 20 and 21, the wavelengths of light selectively reflected by the wavelength selection based reflection layer vary for incidence angles of 65° and 10°. When the reflection curves for these two angles are combined, as shown in FIG. 22, it can be seen that ambient light with the incidence angle of 65° is reflected by the wavelength selection based reflection layer, and then the ambient light with the incidence angle of 10° is reflected again by the wavelength selection based reflection layer, resulting a decreased reflectivity across the entire visible spectrum. As a result, under strong ambient light conditions, the reflected ambient light intensity from the projection screen is significantly reduced.

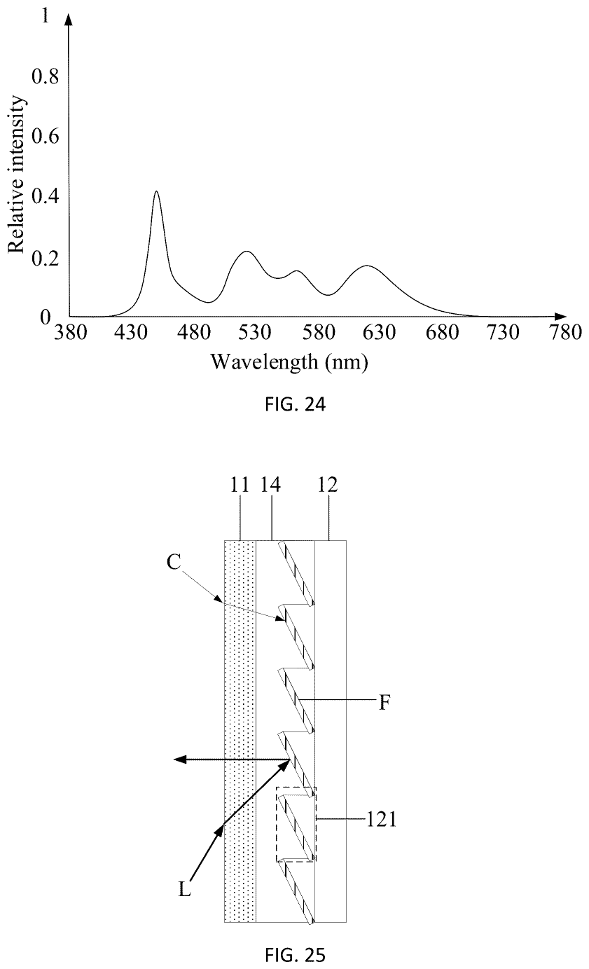

FIG. 23 shows a relative intensity curve of ambient light incident on the projection screen provided in embodiments of the application, and FIG. 24 shows a relative intensity curve of ambient light after reflection by the projection screen provided in embodiments of the application.

Comparing FIGS. 23 and 24 reveals that ambient light with the incidence angle shown in FIG. 19 exhibits high intensity across the visible spectrum when incident on the projection screen. After two reflections in the wavelength selection based reflection layer, its intensity across the visible spectrum decreases significantly. Since ambient light arrives from various directions, it can enter the projection screen at diverse angles. After being diffused by the diffusion layer 11, the incidence angles on the wavelength selection based reflection layer become more varied. This ensures that the reflectivity of incident ambient light significantly decreases across the visible spectrum after multiple reflections in the wavelength selection based reflection layer. Consequently, the projection screen's reflection of ambient light is attenuated, improving the contrast of the projection light.

The application also provides variations of the projection screen structure. FIG. 25 illustrates a fourth schematic structural diagram of the projection screen.

As shown in FIGS. 4 and 25, the projection screen further includes a binding layer 14 located between the diffusion layer 11 and the Fresnel structure layer 12, used to bond the diffusion layer 11 and the Fresnel structure layer 12. The binding layer 14 can be made of adhesive materials such as epoxy resin, acrylic resin, or silicone, with no specific limitation.

In some embodiments, as shown in FIG. 4, the Fresnel structure 121 of the Fresnel structure layer 12 is positioned on the side facing away from the binding layer 14. The binding layer 14 bonds the diffusion layer 11 with the surface of the Fresnel structure layer 12 that faces away from the Fresnel structure 121. When the Fresnel structure is positioned on the side facing away from the binding layer 14, the translucent layer of the wavelength selection based reflection layer F needs to be set on the side closer to the Fresnel structure 121.

In some embodiments, as shown in FIG. 25, the Fresnel structure 121 is positioned on the side facing to the binding layer 14. The binding layer 14 bonds the diffusion layer 11 to the wavelength selection based reflection layer F on the Fresnel structure 121. When the Fresnel structure is positioned on the side closer to the binding layer 14, the translucent layer of the wavelength selection based reflection layer F needs to be set on the side facing away from the Fresnel structure 121. The order of layers in the wavelength selection based reflection layer F differs between FIGS. 4 and 25.

Positioning the Fresnel structure closer to the binding layer 14 allows the binding layer 14 to protect the wavelength selection based reflection layer F. As the Fresnel structure layer 12 is furthest from the viewer and does not receive incident light, its optical transparency and damage resistance requirements are reduced. Therefore, the Fresnel structure layer 12 can be made using less expensive industrial materials rather than expensive optical materials, reducing production costs.

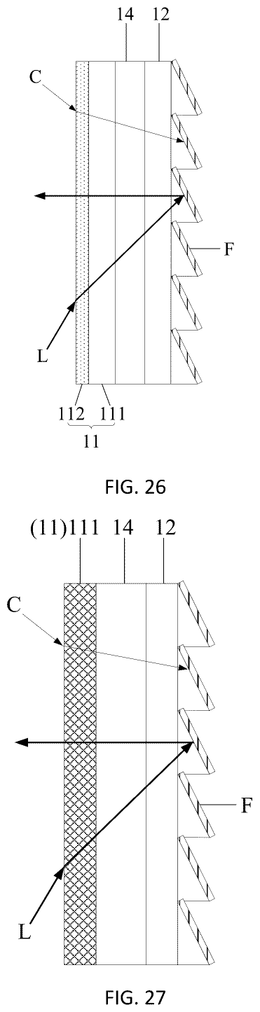

FIG. 26 illustrates a fifth schematic structural diagram of the projection screen.

In some embodiments, as shown in FIG. 26, the diffusion layer 11 includes a second substrate 111 and diffusion material 112.

The second substrate 111 serves as the substrate for the diffusion material 112. The second substrate 111 is in contact with the binding layer 14, while the diffusion material 112 is located on the side of the second substrate 111 facing away from the binding layer 14.

Currently, projection systems often use laser sources, which have high collimation, resulting in projection light with a narrow divergence angle. After reflection by the projection screen, the light remains collimated, limiting the viewing angle. By including the diffusion layer 11, the light exiting the diffusion layer can diverge at various angles, increasing the viewing angle of the projection image. Additionally, the diffusion layer 11 helps reduce laser speckle and optimize the projected image.

The diffusion material 112 can be composed of resin materials or inorganic materials, containing diffusion particles. Diffusion particles can include, but are not limited to, silica particles, alumina particles, titanium dioxide particles, cerium oxide particles, zirconium dioxide particles, tantalum oxide particles, zinc oxide particles, or magnesium fluoride particles. Various coating methods can be used to produce the diffusion material 112, with no specific limitation.

The second substrate 111 can be made of materials such as, but not limited to, PET, polyethylene naphthalate (PEN), polycarbonate (PC), polymethyl methacrylate (PMMA), triacetate cellulose (TAC), cyclic olefin polymer (COP), thermoplastic polyurethane (TPU), polyvinyl chloride (PVC), polyimide (PI), polyamide (PA), polyethylene (PE), or polypropylene (PP).

FIG. 27 illustrates a sixth schematic structural diagram of the projection screen.

In some embodiments, as shown in FIG. 27, the diffusion layer 11 includes only the second substrate 111. This second substrate 111 is in contact with the binding layer 14 and is adhered to the Fresnel structure layer 12 via the binding layer 14. The material of the second substrate 111 contains diffusion material, enabling it to possess light diffusion capabilities and a certain degree of haze upon formation. The second substrate 111, containing the diffusion material, can expand the viewing angle and reduce light reflection, thus preventing the projection of clear images on the ceiling. This anti-reflection feature enhances the viewer's experience.

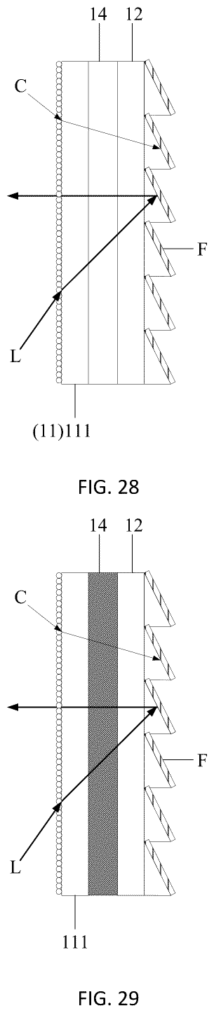

FIG. 28 shows a seventh structural schematic diagram of the projection screen provided by embodiments of the application.

In some embodiments, as shown in FIG. 28, the diffusion layer 11 includes only the second substrate 111, which is in contact with the binding layer 14 and adhered to the Fresnel structure layer 12 through the binding layer 14. The surface of the second substrate 111 facing away from the binding layer 14 is uneven. This uneven surface can be created through sandblasting or alkali treatment of the second substrate 111, without limitation. The uneven surface of the second substrate 111 provides a degree of light diffusion and haze effects, thereby widening the viewing angle and enhancing anti-ceiling reflection capabilities.

FIG. 29 shows an eighth structural schematic diagram of the projection screen provided by embodiments of the application.

In some embodiments, as shown in FIG. 29, the binding layer 14 may contain light-absorbing materials to improve the black luminance of the projection screen by coloring the binding layer. Specifically, deep-colored materials such as carbon black or dyes can be used to color the binding layer 14, deepening its color without limitation.

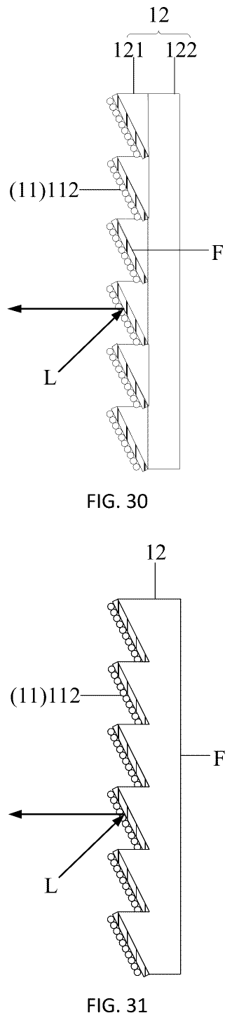

FIG. 30 illustrates a ninth structural schematic diagram of the projection screen provided by embodiments of the application.

In some embodiments, as shown in FIG. 30, the projection screen may consist only of the Fresnel structure layer 12 and the diffusion layer 11. The Fresnel structure layer 12, with its Fresnel structure 121, is positioned on the side facing to the viewer. The diffusion layer 11 is located on the surface of the wavelength selection based reflection layer F facing away from the Fresnel structure layer 12. Here, the diffusion layer is formed by covering the wavelength selection based reflection layer F with the diffusion material 112. This diffusion material 112 can be applied to the surface of the wavelength selection based reflection layer F via coating or spraying. The structure shown in FIG. 30 effectively reduces the thickness of the projection screen.

When adopting the projection screen structure shown in FIG. 30, the translucent layer within the wavelength selection based reflection layer F needs to be positioned on the side facing away from the Fresnel structure 121. The sequence of layers within the wavelength selection based reflection layer F in FIGS. 4 and 30 is reversed.

Specifically, as shown in FIG. 30, the Fresnel structure layer 12 may include the third substrate 122, which has flat surfaces on both the side facing to and facing away from the diffusion layer 11. The Fresnel structure 121 is positioned on the surface of the third substrate 122.

The third substrate 122 may be made of materials such as PET, without limitation. The Fresnel structure 121 can be fabricated using a UV molding process involving a mold with a Fresnel structure and UV-curable resin. This involves coating UV-curable resin onto the mold with the Fresnel structure and pressing the resin with the third substrate 122, followed by UV curing to form the Fresnel structure 121.

FIG. 31 illustrates a tenth structural schematic diagram of the projection screen provided by embodiments of the application.

In some embodiments, as shown in FIG. 31, the Fresnel structure layer 12 can be an integrated structure, with one surface featuring the Fresnel structure 121 and the opposite surface being flat. The integrated Fresnel structure layer eliminates the need to combine a substrate with a Fresnel structure, further simplifying the manufacturing process.

Specifically, an integrated Fresnel structure layer 12 can be produced using thermoforming techniques, employing thermoplastic materials, without limitation.

It should be noted that, the projection screen shown in FIGS. 25-31 describe other film layers with the wavelength selection based reflection layer F covering the inclined faces of the Fresnel structure 121 as examples. In actual implementation, under the same conditions for other film layers, the wavelength selection based reflection layer F may cover both the inclined and connection faces of the Fresnel structure 121.

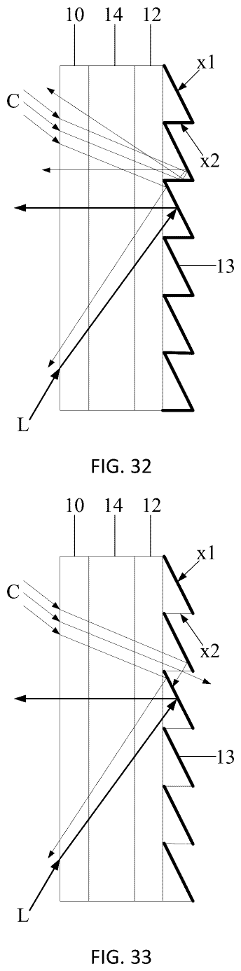

FIG. 32 illustrates a third structural schematic diagram of a projection screen in the related art.

As shown in FIG. 32, projection screens in related art often use vapor deposition or sputtering processes to create the reflective material layer 13, which typically covers the entire surface of the Fresnel structure. Specifically, the reflective material layer 13 covers both the inclined face x1 and the connection face x2 of the Fresnel structure.

When ambient light C enters the projection screen, it may strike both the inclined face x1 and the connection face x2. A portion of the light is reflected off the reflective material layer 13 on the connection face x2 and exits the projection screen, adversely affecting the contrast of projection light.

To enhance the contrast of projection light, removing the reflective material layer 13 from the connection face x2 is considered. FIG. 33 illustrates a fourth structural schematic diagram of a projection screen in the related art.

As shown in FIG. 33, when the reflective material layer 13 is absent from the connection face x2, ambient light C that would have been multiply reflected by the reflective material layer 13 on the connection face x2 can directly exit. Thus the ambient light that would have been reflected toward the viewers will not interfere with the projection light L, thus improving the contrast to some extent.

However, since the reflective material layer on the Fresnel structure surface is typically formed via coating processes, selectively coating only specific surfaces of the Fresnel structure often requires equipment modification, which is technically challenging and costly.

In view of this, the application provides a method for manufacturing a projection screen that avoids dependence on coating equipment. By adjusting the coating conditions and amount, the reflective material layer can be deposited only on the inclined faces of the Fresnel structure, minimizing the coating on the connection faces.

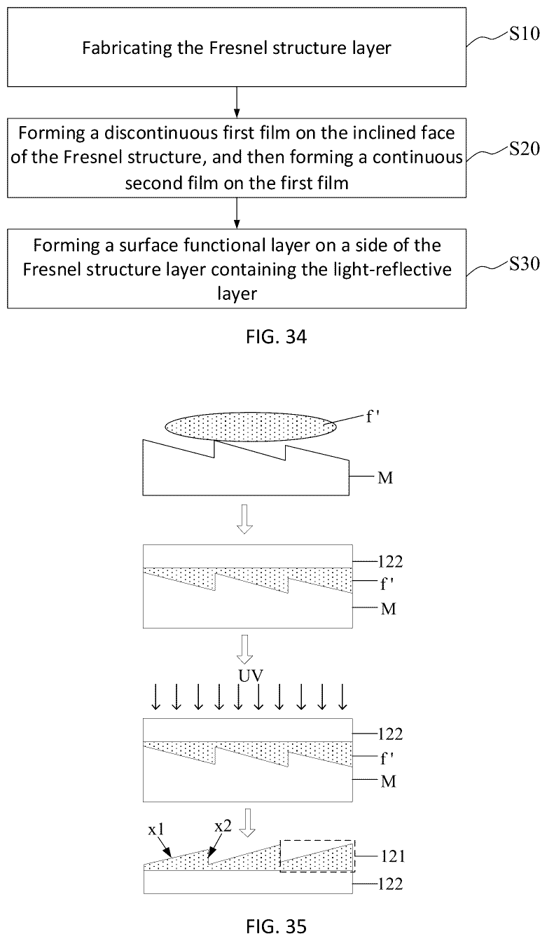

FIG. 34 shows the process flow of the projection screen manufacturing method provided by embodiments of the application.

As illustrated in FIG. 34, the method for manufacturing a projection screen includes:
S10: fabricating the Fresnel structure layer;
S20: forming a discontinuous first film on the inclined face of the Fresnel structure, and then forming a continuous second film on the first film; and
S30: forming a surface functional layer on a side of the Fresnel structure layer containing the light-reflective layer.

In embodiments of the application, the light-reflective layer can either be formed from a single reflective material to create the reflective material layer mentioned above, or it can be made from the wavelength selection based reflection layer described earlier, with no limitation. The light-reflective layer on the Fresnel structure layer can still be produced using vapor deposition or sputtering processes. By adjusting the coating conditions and deposition amounts, a light-reflective layer can be formed on the inclined faces of the Fresnel structure, while minimizing the coating on the connection faces.

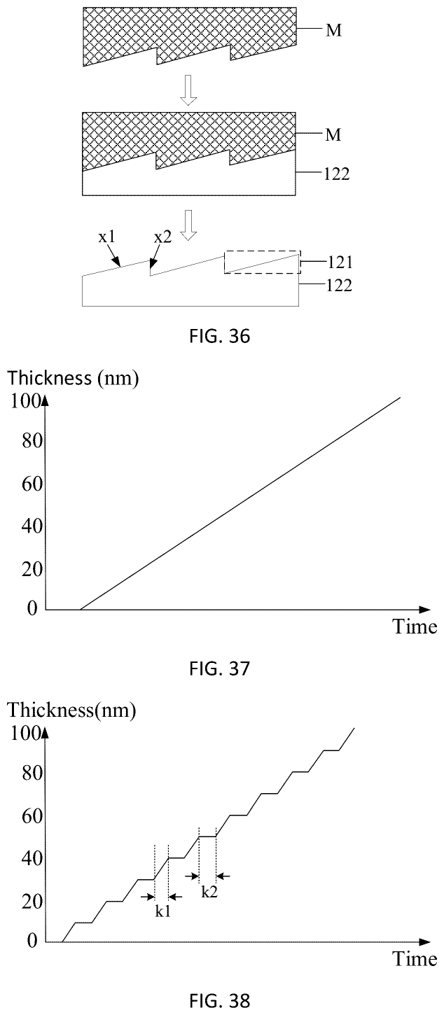

Specifically, various methods can be used to fabricate the Fresnel structure layer. FIG. 35 shows a first manufacturing process for the Fresnel structure layer provided by embodiments of the application, and FIG. 36 shows a second manufacturing process for the Fresnel structure layer provided by embodiments of the application.

In some embodiments, the Fresnel structure 121 can be created by coating UV-curable resin onto a mold M with a Fresnel structure, followed by imprinting the resin onto a substrate and curing it using UV light. As shown in FIG. 35, UV-curable resin f′ is first applied to the mold M with the Fresnel structure. A third substrate 122 is provided, and the UV-curable resin f′ on the mold M is imprinted onto the third substrate 122 under a specified pressure.

Simultaneously, UV light is applied from the third substrate side, curing the resin f′. During the curing process, the resin f′ bonds closely to the third substrate 122, transferring the Fresnel structure of the mold M to the substrate surface, forming the Fresnel structure 121 on the third substrate 122.

When the Fresnel structure layer is formed using UV-curable resin, the substrate and the Fresnel structure are separate entities. In contrast, using a thermoforming method produces an integrated Fresnel structure layer, eliminating the need for bonding the substrate to the Fresnel structure. As shown in FIG. 36, the integrated Fresnel structure layer is produced using thermoplastic materials such as TPU or PVC. First, a thermoplastic third substrate 122 is provided. A heated mold M with the Fresnel structure is used to thermoform the third substrate 122, thereby creating the Fresnel structure layer with the Fresnel structure 121.

As shown in FIGS. 35 and 36, the fabricated Fresnel structure layer's surface contains a plurality of Fresnel structures 121. Depending on the application and manufacturing process, these Fresnel structures 121 may form concentric circular patterns that expand radially or linear structures that extend horizontally across the projection screen and are arranged vertically. There are no limitations on these configurations.

To form a light-reflective layer exclusively on the inclined faces x1 of the Fresnel structure without coating the connection faces x2, the application implements adjustments to the coating conditions and deposition amounts during the light-reflective layer's fabrication process.

Specifically, the application introduces multiple interruptions in the coating process, causing the coating periods and interruption intervals to alternate.

FIG. 37 shows the coating thickness curve in related art, while FIG. 38 shows the coating thickness curve provided by embodiments of the application.

As shown in FIG. 37, in related art, the deposition process is continuous, resulting in a reflective material film being formed continuously over both the inclined faces x1 and the connection faces x2 of the Fresnel structure.

However, in the application, as shown in FIG. 38, by introducing multiple interruption intervals k2 during the coating process, coating periods k1 and interruptions k2 alternate throughout the process. By controlling the durations of k1 and k2, as well as the deposition amounts, a discontinuous first thin film is initially formed on the inclined faces x1 of the Fresnel structure. Subsequently, a continuous second thin film is formed over the first thin film. This ensures a continuous film is formed only on the inclined faces x1, while the deposition on the connection faces x2 is minimized.

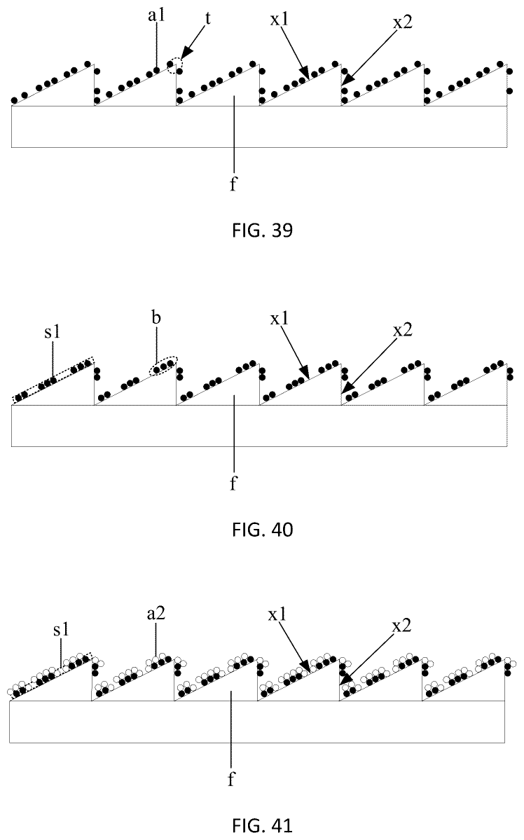

FIGS. 39 to 42 illustrate the structure of the reflection layer during the coating process provided by embodiments of the application.

Specifically, the process of forming a reflection layer transitions from “nucleation→nucleus aggregation→islands→island aggregation→continuous film.” The states up to island aggregation are considered discontinuous thin films. These forms are generally correlated with film thickness, which largely depends on deposition time. Deposition time, in turn, is influenced by the deposition rate.

Based on this principle, the application inserts interruption intervals into the coating process, adjusting deposition time and rate to first form a discontinuous first thin film on the inclined faces x1 of the Fresnel structure.

As shown in FIG. 39, a sharp step t forms at the boundary between the inclined face x1 and connection face x2 of each Fresnel structure. At lower deposition amounts, incident atoms are suppressed around the step t, with most atoms a1 depositing on the inclined face x1. Only the area near the step on the connection face x2 receives atoms a1.

As shown in FIG. 40, after the coating period ends, the process is paused, allowing the deposited atoms to stabilize into nuclei b. The step t inhibits atom redirection onto the connection face x2, promoting the formation of a discontinuous first thin film s1 on the inclined face x1.

As shown in FIG. 41, after the interruption ends, deposition resumes, causing incoming atoms a2 to accumulate around the existing nuclei, increasing the height around the first thin film s1. This promotes further deposition in these regions.

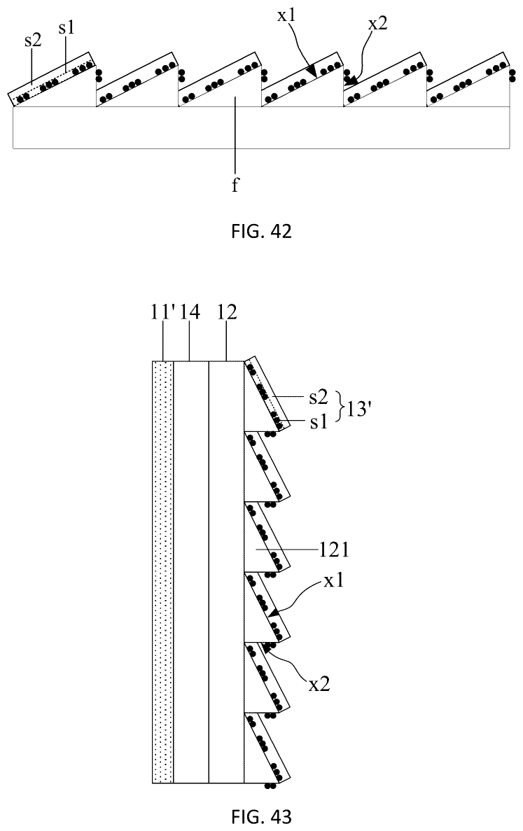

As shown in FIG. 42, after multiple coating periods, the thin film continues to grow, eliminating the initial nuclei to form a continuous second thin film s2 over the inclined face x1.

During implementation, the duration of the interruption k2 is longer than that of the coating period k1, and longer interruptions k2 yield better results. For practical operability, the interruption k2 can range from 30 to 60 seconds, while coating period k1 can range from 1 to 10 seconds (e.g., around 5 seconds).

Thus, light-reflective layers can be formed on the inclined faces of the Fresnel structures. After obtaining the Fresnel structure layer with light-reflective layers on its surface, a surface functional layer can be formed on the other side of the Fresnel structure layer.

The surface functional layer is typically located on the outermost side of the projection screen. In the application, the surface functional layer can be processed in various ways to achieve effects such as a wider viewing angle, reduced ambient light reflection, and resistance to ceiling reflections. Methods for producing the surface functional layer include adhesion, spraying, and etching, depending on the type of surface functional layer required, with no limitations.

In some embodiments, the light-reflective layer can adopt the wavelength selection based reflection layer F described earlier, while the surface functional layer can adopt the diffusion layer 11 mentioned above.

When the light-reflective layer adopts the wavelength selection based reflection layer F, it includes a translucent layer 131, a light-transmissive medium layer 133, and a reflection layer 132 arranged in stack. To ensure the wavelength selection based reflection layer forms only on the inclined faces x1 of the Fresnel structure, any layer within the wavelength selection based reflection layer (translucent layer 131, light-transmissive medium layer 133, or reflection layer 132) can be fabricated using the discontinuous coating process described earlier. In this process, a discontinuous first thin film is first formed, followed by a continuous second thin film. The first and second thin films can be made from the same or different materials as needed. When they are made from the same material, the final films will have no apparent boundary and will form a continuous layer solely on the inclined faces of the Fresnel structures.

In the embodiments of the application, when fabricating the reflection layer 132 of the wavelength selection based reflection layer F using the aforementioned discontinuous coating process, the thickness of the discontinuous film typically ranges from 1 nm to 10 nm. Therefore, the thickness of the first thin film s1 formed on the reflection layer 132 is 1 nm˜10 nm. To ensure the second film s2 in the reflection layer 132 exhibits excellent light-reflecting properties, the thickness of the second film s2 in embodiments of the application is 50 nm˜200 nm. Generally, the thickness of the second film s2 is controlled below 500 nm to prevent excessive thickness.

The initially formed first thin film s1, being a thin and discontinuous film, lacks reflective properties. It serves to guide subsequent deposition preferentially onto the inclined surface and can be made from metal materials or transparent dielectric materials. Metals such as Ag or Al may be used, while dielectric materials may include Al₂O₃, Nb₂O₅, TiO₂, ITO, or SiO₂, without restriction.

The second film s2, located on the first thin film s1, is used for reflecting projection light and may also be formed from reflective metals such as Ag or Al, without limitation.

Similarly, the translucent layer 131 and the light-transmissive medium layer 133 of the wavelength selection based reflection layer F can also be fabricated using the discontinuous coating process, ensuring deposition occurs only on the inclined surface x1 of the Fresnel structure while minimizing coating on the connection surface x2.

It should be noted that, since the light-transmissive medium layer is made from light-transmitting materials, when it forms on the inclined surface x1 and connection surface x2, it exhibits only light transmittance performance. The film exhibiting light transmittance performance formed on the connection face x2 does not interfere with light. Therefore, traditional continuous coating processes can also be used for these layers, without limitation. Generally, discontinuous coating is preferred for cost-saving purposes.

In some embodiments, the translucent layer 131 may first be formed on the Fresnel structure, followed sequentially by the light-transmissive medium layer 133 and the reflection layer 132. The translucent layer 131 may be fabricated using discontinuous coating techniques, while the light-transmissive medium layer 133 and the reflection layer 132 may be formed sequentially using the same discontinuous coating techniques. Alternatively, since the translucent layer 131 allows most light to pass while reflecting a small portion, it can be fabricated using conventional coating techniques, while the light-transmissive medium layer 133 and the reflection layer 132 are fabricated using discontinuous coating methods.

For structures where the light-reflective layer is made only from reflective material, the light-reflective layer can also be fabricated using discontinuous coating methods. Specifically, the first thin film s1 with a thickness of 1 nm to 10 nm is formed on the inclined surface x1, followed by the second film s2 with a thickness of 50 nm to 200 nm on top of the first film s1.

Based on the same inventive concept, embodiments of the application also provide a projection screen fabricated using the above methods. FIG. 43 illustrates the structural schematic of the projection screen.

As shown in FIG. 43, the projection screen includes: a surface functional layer 11′, a Fresnel structure layer 12, and a light-reflective layer 13′.

The surface functional layer 11′ is located on the outermost side of the projection screen, nearest the viewers, protecting the projection screen and optionally undergoing various treatments to achieve effects such as wider viewing angles, reduced ambient light reflection, and prevention of ceiling glare. In some embodiments, the surface functional layer 11′ may adopt the above diffusion layer 11.

The Fresnel structure layer 12 is positioned on a side of the surface functional layer 11′, specifically on the side farthest from the viewer. The Fresnel structure layer 12 includes, on one side, a plurality of Fresnel structures 121 arranged according to a set rule. The Fresnel structure 121 includes interconnected inclined surface x1 and connection surface x2.

The light-reflective layer 13′ is located on the inclined surface x1 of each Fresnel structure 121. In the embodiments of the application, the light-reflective layer 13′ is formed using vapor deposition or sputtering methods with established deposition or sputtering equipment, avoiding the need for equipment modifications. By simply adjusting the deposition conditions and deposition amounts as well as adopting discontinuous coating techniques, the light-reflective layer can be formed on the inclined faces of the Fresnel structures, so that the deposition amount on the connection faces can be minimized, avoiding the issues of equipment adjustment difficulty and expensive cost.

In some embodiments, the light-reflective layer 13′ may correspond to the reflective material layer 13 in related art.

In some embodiments, the light-reflective layer 13′ may be the wavelength selection based reflection layer F.

Any layer within the light-reflective layer 13′ can utilize the discontinuous thin film process to form a first discontinuous film s1 on the inclined surface x1 and subsequently form a second film s2 on the first film s1.

In the projection screen provided in embodiments of the application, only the inclined faces of the Fresnel structures is provided with light-reflective layers, thus the ambient light incident on the connection faces can exit directly from the connection faces. The ambient light that would have been reflected toward the viewers will no longer interfere with the projection light, thereby improving the contrast of the projection light to some extent.

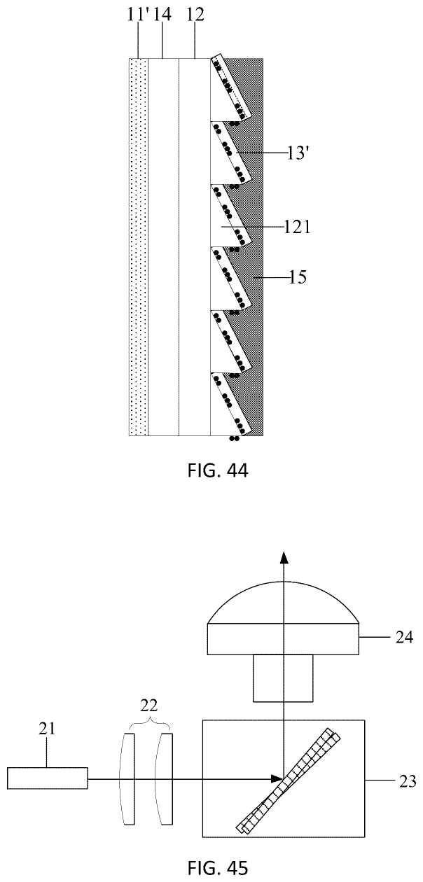

FIG. 44 shows a twelfth structural schematic diagram of a projection screen provided in embodiments of the application.

As shown in FIG. 44, a light-absorbing layer 15 may be provided on the side of the Fresnel structure layer 12 facing away from the surface functional layer 11′. The light-absorbing layer may absorb the light emitted from the connection faces x2 of the Fresnel structures to prevent this part of the light from being re-incident into the projection screen after reflection or the like. The light absorbing layer 15 can be realized by doping the film layer with light absorbing materials. For example, carbon black or dye can be added to the film layer material to color the film layer so that it can absorb light, which is not limited here.

The projection screen provided in embodiments of the application may further include a binding layer. The position of the binding layer and the variations of the projection screen can refer to the above embodiments and will not be described again here.

The embodiments of the application also provide a projection system, as shown in FIG. 1, including: a projection device 2, and a projection screen 1 on a light-emitting side of the projection device 2.

FIG. 45 shows the structural schematic diagram of the projection device.

As shown in FIG. 45, the projection device includes: a light source 21, an illumination path 22, a light modulator 23, and a projection lens 24. The illumination path 22 is positioned at a light-emitting side of the light source 21, the light modulator 23 is positioned at a light-emitting side of the illumination path 22, and the projection lens 24 is positioned at a light-emitting side of the light modulator 23.

The light source 21 can employ a laser source. The laser source may use a monochromatic laser, a laser capable of emitting multiple colors, or multiple lasers that emit different colors. When a monochromatic laser is used, the projection device must also include a color wheel to perform color conversion, allowing the monochromatic laser in conjunction with the color wheel to emit different primary colors sequentially over time. When a laser capable of emitting multiple colors is used, the laser source is controlled to emit different colored laser light sequentially as primary colors.

In the embodiments of the application, the light source 21 can use a three-color laser source. The three-color laser source may be a single laser emitting three primary colors, such as an MCL laser, or it may include separate red laser, green laser, and blue laser emitting the light of three primary colors. The use of a three-color laser source enhances the color gamut of the projection image, providing better color reproduction and accurately rendering the input image.

The illumination path 22, located at the light-emitting side of the light source 21, used for both collimating the light emitted from the light source 21 and directing the light to the light modulator 23 at an appropriate angle. The illumination path 22 may include multiple lenses or lens groups without specific limitations.

The light modulator 23 modulates the incident light. Specifically, the light modulator 23 can employ a Digital Micromirror Device (DMD). After passing through the illumination path 22, the light beam meets the required illumination size and incident angle for the DMD. The surface of the DMD consists of numerous micro-mirrors, each of which can be individually controlled to tilt. By adjusting the tilt angles of the DMD, the brightness of light entering the projection lens 24 can be modulated.

The projection lens 24 is used to image the light emitted by the light modulator 23. After imaging, the formed image can be projected by the projection lens 24.

In embodiments of the application, the projection device 2 can use an ultra-short-focus projection device, where the projection lens 24 is an ultra-short-focus lens. Ultra-short-focus projection devices significantly reduce the distance between the projection device 2 and the projection screen 1, enabling large-sized image displays while minimizing the required projection distance.

The projection screen 1 is positioned on the light-emitting side of the projection lens within the projection device. The projection screen 1 includes a diffusion layer, a Fresnel structure layer, and a wavelength selection based reflection layer located on at least part of Fresnel structures on the Fresnel structure layer's surface. The wavelength selection based reflection layer selectively reflects the projection light emitted by the projection device while significantly reducing the reflectivity of light of other wavelength bands. This design allows the projection screen to appear black when the projection device is off and to display bright images when it is on, thereby significantly improving the contrast of the projected image.

Although the preferred embodiments of the invention have been described, those skilled in the art, upon learning the basic inventive concepts, can make further modifications and variations to these embodiments. Therefore, the appended claims are intended to be interpreted to include the preferred embodiments and all modifications and changes falling within the scope of the invention.

Apparently, those skilled in the art may make various modifications and variations to the disclosure without departing from the spirit and scope of the disclosure. Thus, if these modifications and variations fall within the scope of the claims and their equivalents, the disclosure is intended to include these modifications and variations.

What is claimed is:

1. A projection screen, comprising:
a diffusion layer;
a Fresnel structure layer with a plurality of Fresnel structures that are sequentially arranged, on a side of the diffusion layer; and
a wavelength selection based reflection layer, covering at least part of a surface of the Fresnel structure of the Fresnel structure layer;
wherein
a reflectivity for projection light emitted from a projection device by the wavelength selection based reflection layer is higher than a reflectivity for light of other wavelength bands by the wavelength selection based reflection layer; and
the projection light comprises red laser light, green laser light, and blue laser light, wherein a wavelength band of the red laser light ranges from 635 nm to 650 nm, a wavelength band of the green laser light ranges from 520 nm to 532 nm, and a wavelength band of the blue laser light ranges from 445 nm to 465 nm.

2. The projection screen according to claim 1, wherein the Fresnel structure comprises: an inclined face and a connection face that are interconnected;
the inclined face is tilted relative to a plane of the diffusion layer;
the wavelength selection based reflection layer covers the inclined face of the Fresnel structure; and
a tilt angle of the inclined face satisfies a condition for reflecting the projection light incident on the wavelength selection based reflection layer on the inclined face toward a viewer of the projection screen.

3. The projection screen according to claim 1, wherein the wavelength selection based reflection layer comprises:
a translucent layer on a side closer to the diffusion layer;
a reflection layer on a side of the translucent layer facing away from the diffusion layer; and
a light-transmissive medium layer between the translucent layer and the reflection layer;
wherein a product of a refractive index of the light-transmissive medium layer and a thickness of the light-transmissive medium layer satisfies a condition that allows the projection light emitted from the projection device to resonate.

4. The projection screen according to claim 3, wherein the translucent layer is formed of a laminated structure comprising at least one of aluminum, niobium, silver, or titanium; and
a thickness of the translucent layer ranges from 2 nm to 20 nm.

5. The projection screen according to claim 3, wherein the reflection layer is made of aluminum, aluminum alloy, silver, or silver alloy; and
a thickness of the reflection layer is greater than 50 nm and less than 100 nm.

6. The projection screen according to claim 3, wherein the light-transmissive medium layer is made of metal oxides, nitrides, or transparent resins.

7. The projection screen according to claim 6, wherein the light-transmissive medium layer is made of at least one of TiO₂, Nb₂O₅, ZrO₂, Al₂O₃, ZnO₂, or SiO₂.

8. The projection screen according to claim 6, wherein the product of the refractive index of the light-transmissive medium layer and the thickness of the light-transmissive medium layer ranges from 1200 nm to 1400 nm, satisfying a condition for the wavelength selection based reflection layer to simultaneously reflect the red laser light, the green laser light, and the blue laser light.

9. The projection screen according to claim 1, wherein a center wavelength of the red laser light reflected by the wavelength selection based reflection layer is 635 nm, 650 nm, or 643 nm;
a center wavelength of the green laser light reflected by the wavelength selection based reflection layer is 520 nm, 525 nm, or 532 nm; and
a center wavelength of the blue laser light reflected by the wavelength selection based reflection layer is 445 nm or 465 nm.

10. The projection screen according to claim 3, wherein the wavelength selection based reflection layer further comprises a first substrate on a side of the translucent layer facing away from the light-transmissive medium layer.

11. The projection screen according to claim 2, further comprising:
a binding layer between the diffusion layer and the Fresnel structure layer;
wherein
an inclined angle of the Fresnel structure of the Fresnel structure layer faces away from the binding layer, and the binding layer is used to bond the diffusion layer and a surface, opposite to the inclined angle of the Fresnel structure, of the Fresnel structure layer; or
an inclined angle of the Fresnel structure faces to the binding layer, and the binding layer is used to bond the diffusion layer to the wavelength selection based reflection layer on the Fresnel structure;
wherein the binding layer comprises light-absorbing material.

12. The projection screen according to claim 1, wherein
the inclined angle of the Fresnel structure of the Fresnel structure layer faces a viewer of the projection screen;
the diffusion layer is located on a surface of the wavelength selection based reflection layer facing away from the Fresnel structure layer;
wherein the diffusion layer is a coating of diffusion material covering the wavelength selection based reflection layer.

13. The projection screen according to claim 1, wherein the Fresnel structure layer comprises:
a third substrate, wherein a surface facing to the diffusion layer and a surface facing away from the diffusion layer both are flat surfaces, and the Fresnel structure is located on one of surfaces of the third substrate; or
the Fresnel structure layer is an integrated structure with one surface provided with the Fresnel structure and an opposite surface being flat.

14. The projection screen according to claim 2, further comprising:
a light-absorbing layer on a side of the Fresnel structure layer facing away from the diffusion layer;
wherein the light-absorbing layer is used to absorb ambient light emitted from the connection face of the Fresnel structure.

15. The projection screen according to claim 14, wherein the light-absorbing layer is a film layer doped with light-absorbing material.

16. A method for manufacturing a projection screen, comprising:
a Fresnel structure fabrication step, comprising: fabricating a Fresnel structure layer with a plurality of Fresnel structures; wherein the Fresnel structure comprises an inclined face and a connection face that are interconnected;
a light-reflective layer fabrication step, comprising: forming a first film that is discontinuous on the inclined face of the Fresnel structure and a second film that is continuous on the first film;
a surface functional layer fabrication step, comprising: forming a surface functional layer on a side of the Fresnel structure layer with the light-reflective layer.

17. The method according to claim 16, wherein the light-reflective layer fabrication step employs a vapor deposition process or sputtering process;
the light-reflective layer fabrication step comprises:
inserting a plurality of interruptions in a coating process in such a way that coating periods and interruptions alternate;
wherein a duration of the interruption is longer than a duration of the coating period; and
the duration of the interruptions ranges from 30s to 60s and the duration of the coating period ranges from 1s to 10s.

18. The method according to claim 16, wherein the light-reflective layer is a wavelength selection based reflection layer, and comprises:
a translucent layer on a side closer to the surface functional layer;
a reflection layer on a side of the translucent layer facing away from the surface functional layer; and
a light-transmissive medium layer between the translucent layer and the reflection layer;
wherein a product of a refractive index of the light-transmissive medium layer and a thickness of the light-transmissive medium layer satisfies a condition that allows projection light emitted from a projection device to resonate;
wherein any one of layers in the wavelength selection based reflection layer is fabricated by first forming a first film that is discontinuous and forming a second film that is continuous on the first film.

19. The method according to claim 18, wherein the first film in the reflection layer is made of metal or a transparent dielectric material, and the second film is made of metal;
a thickness of the first film ranges from 1 nm to 10 nm, and a thickness of the second film ranges from 50 nm to 200 nm.

20. A projection system, comprising:
a projection device for emitting projection light; and
a projection screen according to claim 1, wherein the projection screen is located on a light-emitting side of the projection device;
wherein the projection device is an ultra-short-focus laser projection device, comprising:
a three-color laser source for emitting three primary color laser light;
a light modulator at a light-emitting side of the three-color laser source for modulating the three primary color laser light; and
a projection lens on a light-emitting side of the light modulator.
